(19) United States
(12) Patent Application Publication
(10) Pub. No.: US 2008/0144555 A1
(43) Pub. Date: Jun. 19, 2008

(54) Apparatus and method for identifying header compression channel in broadband wireless communication system

(75) Inventors: Young-Ki Hong, Seoul (KR); Kyu-Tae Choi, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 11/998,269

(22) Filed: Nov. 29, 2007

(30) Foreign Application Priority Data
Nov. 29, 2006 (KR) 2006-0118737

(51) Int. Cl. H04B 7/00; H04L 12/56; H04J 3/18

(52) U.S. Cl. 370/310; 370/392; 455/72; 370/477

(57) ABSTRACT

A header compression in a broadband wireless communication system is provided. A transmitter includes a compressor for compressing a header of a packet; a processor for appending a compression channel IDentifier (ID) to the packet; and a controller for identifying a Service Flow (SF) corresponding to the compression channel ID and processing the packet according to the SF. Accordingly, by using the ID of the compression channel in the header compression, the SF can be identified even in the header compression.

### CROSS-REFERENCE TO RELATED APPLICATION(S) AND CLAIM OF PRIORITY

This application claims priority under 35 U.S.C. §119(a) to an application filed in the Korean Intellectual Property Office on Nov. 29, 2006 and assigned Ser. No. 2006-118737, the contents of which are incorporated herein by reference.

### TECHNICAL FIELD OF THE INVENTION

The present invention relates generally to a broadband wireless communication system, and in particular, to an apparatus and method for identifying a header compression channel in the broadband wireless communication system.

### BACKGROUND OF THE INVENTION

The fourth generation (4G) communication system, which is a next-generation communication system, has been researched and developed to provide services of various Quality of Services (QoSs) to users at a data rate of about 100 Mbps. Specifically, research in 4 G communication systems has been conducted into a high rate service support to guarantee mobility and QoS in Broadband Wireless Access (BWA) communication systems, such as local area network systems and metropolitan area network systems. Representative 4 G communication systems include Institute of Electrical and Electronics Engineers (IEEE) 802.16 communication systems.

A wireless access specification of the IEEE 802.16 communication system largely includes a media access control (MAC) layer and a physical layer. The MAC layer is divided into a MAC Convergence Sublayer (CS), a MAC Common Part Sublayer (CPS), and a MAC Privacy Sublayer (PS). The MAC CS converts service protocols for digital audio and video multicasts, digital telephone, and Internet access in accordance with the IEEE 802.16 protocol. The MAC CPS generates a frame, sends data, controls access to the wireless media, and controls the flow of data and control signals. The MAC PS takes charge of the security.

Recently, communication system developers, such as IEEE 802.16 developers, have considered the adoption of a header compression scheme, such as RObust Header Compression (ROHC) to raise the efficiency of the radio channel. By applying the ROHC scheme, an ROHC layer is added and the CS is divided into an Internet Protocol (IP) CS and an IP with ROHC CS in the MAC layer as shown in FIG. 1. The IP CS is the CS for associating the IP with the IEEE 802.16. ROHC Service Access Point (SAP), CS SAP, and MAC SAP in FIG. 1 indicate interfaces between the layers.

When a packet A 101 of FIG. 1 arrives at the ROHC layer via the IP layer, the ROHC layer filters the packet A 101. That is, the ROHC layer confirms whether the packet is to be compressed or not and then compresses a header according to the ROHC scheme. Next, the packet A 101 is fed to the IP with ROHC CS. The IP with ROHC CS determines which Service Flow (SF) the packet A 101 belongs to by checking a context ID of the packet A 101. Next, the MAC CPS sends the packet A 101 in the corresponding SF according to the result of the determination. Herein, the context ID is an identifier signifying the form of the compressed header; that is, signifying which part of the header is compressed.

A packet B 103 header-compressed according to the ROHC scheme is fed to the IP with ROHC CS via the MAC CPS. The IP with ROHC CS provides the packet B 103 to the ROHC layer. Next, the ROHC layer recovers the header of the packet B 103 using the ROHC scheme and provides the recovered packet to the IP layer.

The SF is in the one-to-one correspondence with the ROHC channel; that is, with a pair of logical ROHC compressor and decompressor. In this case, each ROHC channel includes a plurality of context IDs. Accordingly, a packet may have the same context ID even with the different SF. In specific, using only the context ID, the SF of the packet cannot be identified. Also, when the ROHC-compressed packet arrives at the ROHC layer via the IP with ROHC CS, it is impossible to identify to which ROHC channel the packet belongs.

### SUMMARY OF THE INVENTION

To address the above-discussed deficiencies of the prior art, it is a primary aspect of the present invention to substantially solve at least the above problems and/or disadvantages and to provide at least the advantages below. Accordingly, an aspect of the present invention is to provide an apparatus and method for identifying a Service Flow (SF) of a header-compressed packet in a broadband wireless communication system.

Another aspect of the present invention is to provide an apparatus and method for adding an identifier (ID) indicative of a compression channel when a header is compressed in a broadband wireless communication system.

The above aspects are achieved by providing a transmitter in a broadband wireless communication system, which includes a compressor for compressing a header of a packet; a processor for appending a compression channel IDentifier (ID) to the packet; and a controller for identifying a Service Flow (SF) corresponding to the compression channel ID and processing the packet according to the SF.

According to one aspect of the present invention, a receiver in a broadband wireless communication system includes a processor for appending a compression channel ID corresponding to a Service Flow (SF) of a header-compressed packet; and a decompressor for identifying a compression channel of the packet based on the compression channel ID and recovering the header of the packet in the corresponding compression channel.

According to the aspect of the present invention, a method for compressing a header of a packet in a broadband wireless communication system includes compressing a header of a packet; appending a compression channel ID to the packet; identifying a SF corresponding to the compression channel ID; and processing the packet according to the SF.

According to the aspect of the present invention, a method for recovering a compressed header of a packet in a broadband wireless communication system includes examining whether a header-compressed packet is received or not; appending a compression channel ID corresponding to a SF of the packet; identifying a compression channel of the packet based on the compression channel ID; and recovering the header of the packet in the identified compression channel.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a logical structure of a wireless access specification in a general broadband wireless communication system;

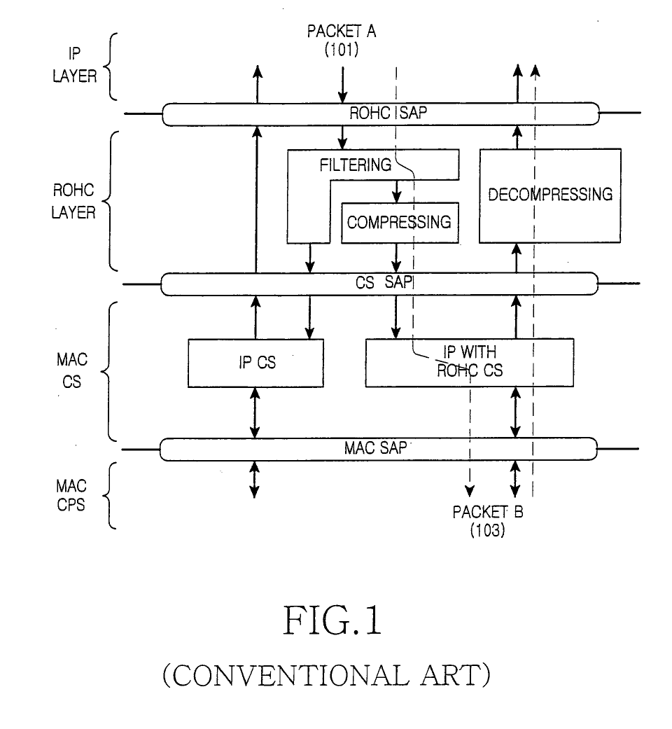

FIG. 2 illustrates a transmitter in a broadband wireless communication system according to the present invention;

FIG. 3 illustrates a receiver in the broadband wireless communication system according to the present invention;

FIG. 4 illustrates a method for compressing a packet header at the transmitter in the broadband wireless communication system according to the present invention;

FIG. 5 illustrates a method for decompressing the packet header at the receiver in the broadband wireless communication system according to the present invention; and

FIGS. 6A and 6B illustrate the header-compressed packet according to the present invention.

### DETAILED DESCRIPTION OF THE INVENTION

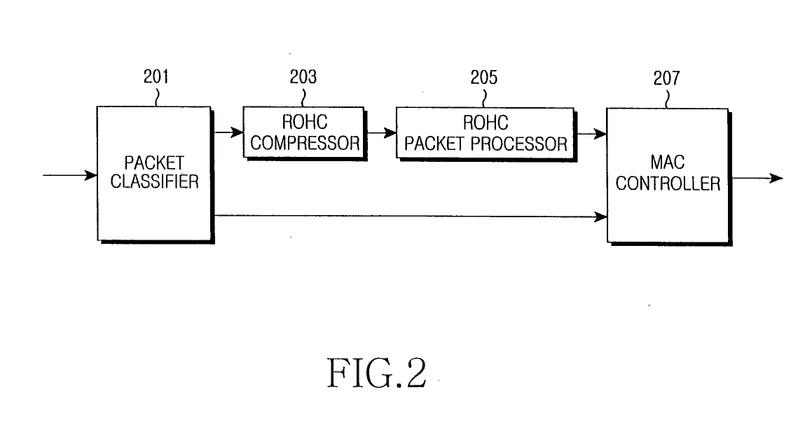

FIGS. 2 through 6B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention provides a technique for identifying a Service Flow (SF) of a header-compressed packet in a broadband wireless communication system. Hereinafter, the header compression adopts a RObust Header Compression (ROHC) scheme by way of example, but the present invention is applicable to other header compression schemes.

FIG. 2 is a block diagram of a transmitter in a broadband wireless communication system according to the present invention.

The transmitter of FIG. 2 includes a packet classifier 201, an ROHC compressor 203, an ROHC packet processor 205, and a Media Access Control (MAC) controller 207.

The packet classifier 201 examines whether the ROHC is to be applied to a packet provided from an upper layer (e.g., Internet Protocol (IP) layer). Whether to apply the ROHC is determined when an SF is generated between the transmitter and a receiver of the packet. The packet classifier 201 determines whether to apply the ROHC based on the service characteristic, which is not described in detail.

The ROHC compressor 203 compresses a header of the packet fed from the packet classifier 201 using the ROHC scheme. In detail, the ROHC compressor 203 compresses the header of the fed packet and adds information for the decompression (e.g. context ID).

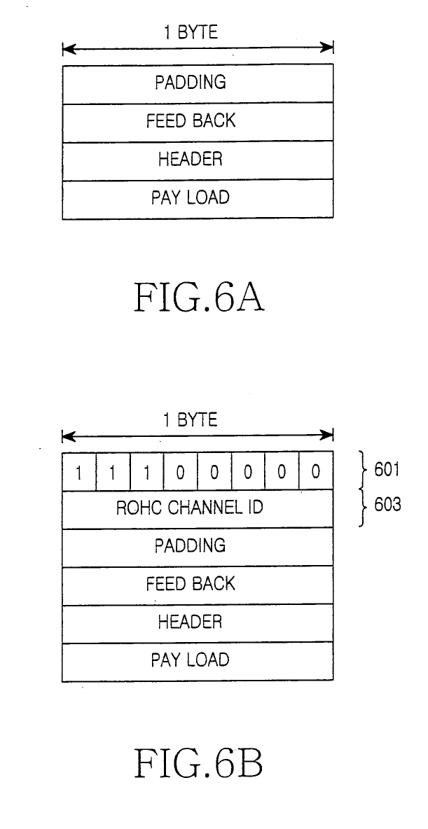

The ROHC packet processor 205 adds a ROHC channel ID to the ROHC packet header-compressed at the ROHC compressor 203. For example, the ROHC packet processor 205 receives the ROHC packet of FIG. 6A and appends a padding 601 and a ROHC channel ID 603 as shown in FIG. 6B. The padding 601 is a predefined sequence indicative of the ROHC packet and is the same as the padding of FIG. 6A. The ROHC channel ID is an identifier for discriminating the ROHC channel.

The MAC controller 207 executes functions of the transmitter MAC layer. The MAC controller 207 processes the packets fed from the ROHC packet processor 205 and the packet classifier 201 according to their corresponding Service Flows (SFs). Particularly, according to the present invention, the MAC controller 207 receives the ROHC packet from the ROHC packet processor 205 and identifies the SF of the ROHC packet by checking the SF ID corresponding to the ROHC channel ID of the ROHC packet. Next, the MAC controller 207 eliminates the ROHC channel ID and the ROHC padding from the ROHC packet and processes the packet according to the identified SF. In other words, the MAC controller 207 confirms a Connection ID (CID) corresponding to the identified SF and processes to send the ROHC packet to the receiver indicated by the CID.

The blocks constructed as above belong to their respective layers. The packet classifier 201, the ROHC compressor 203, and the ROHC packet processor 205 belong to an ROHC layer, and the MAC controller 207 belongs to a MAC Convergence Sublayer (CS).

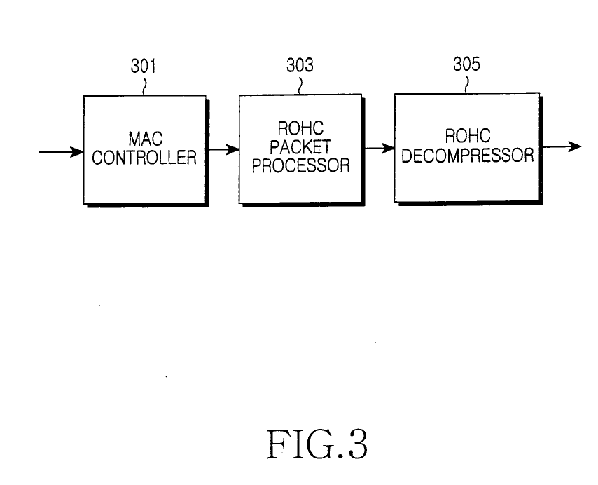

FIG. 3 illustrates a receiver in the broadband wireless communication system according to the present invention.

The receiver of FIG. 3 includes a MAC controller 301, an ROHC packet processor 303, and an ROHC decompressor 305.

The MAC controller 301 executes functions of the receiver MAC layer. The MAC controller 301 provides a packet from a lower layer to an upper layer according its corresponding SF.

The ROHC packet processor 303 receives the ROHC packet from the MAC controller 301 and adds the padding 601 and the ROHC channel ID 603 as shown in FIGS. 6A and 6B. The padding 601 is a predefined sequence indicative of the ROHC packet and is the same as the padding of FIG. 6A. The ROHC channel ID 603 is an identifier for discriminating the ROHC channel.

The ROHC decompressor 305 confirms the ROHC channel ID of the ROHC packet fed from the ROHC packet processor 303, decompresses the compressed header in the corresponding ROHC channel, and outputs the decompressed packet to the upper layer.

The blocks constructed as above belong to their respective layers. The MAC controller 301 and the ROHC packet processor 303 belong to the MAC CS, and the ROHC decompressor 305 belongs to the ROHC layer.

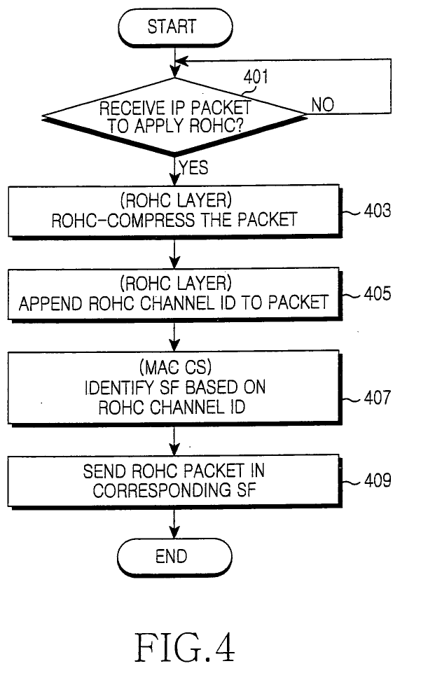

FIG. 4 illustrates a method for compressing the packet header at the transmitter in the broadband wireless communication system according to the present invention.

The transmitter examines whether the packet to be applied to the ROHC is received from the upper layer in step 401. If the transmitter is a terminal, the packet is generated according to the process in the terminal. If the terminal is a system equipment such as Access Control Router (ACR), the packet is received over a core network such as IP network.

Upon receiving the packet to be applied to the ROHC, the transmitter compresses the header of the packet using the ROHC scheme in step 403. In specific, the transmitter compresses the header of the received packet and generates a ROHC packet by adding the information for the decompression (e.g., context ID).

Next, the transmitter appends the ROHC channel ID and the padding to the ROHC packet in step 405. For example, the packet with the ROHC channel ID and the padding appended is shown in FIG. 6B. The padding 601 is a predefined sequence indicative of the ROHC packet and is the same as the padding of FIG. 6A. The ROHC channel ID 603 is an identifier for discriminating the ROHC channel.

In step 407, the transmitter identifies the SF corresponding to the ROHC channel by checking the ROHC channel ID of the ROHC packet and the corresponding SF ID.

In step 409, the transmitter removes the ROHC channel ID and the padding from the ROHC packet and processes the packet according to the corresponding SF. That is, the transmitter confirms the CID corresponding to the SF and sends the ROHC packet to the receiver identified through the CID.

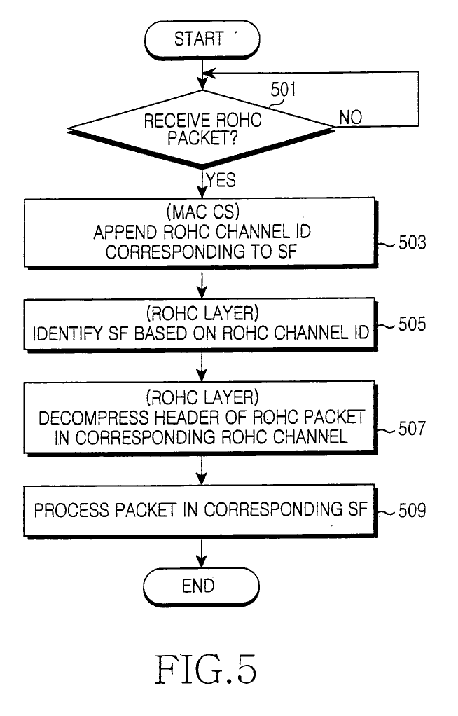

FIG. 5 illustrates a method for recovering the compressed packet header at the receiver in the broadband wireless communication system according to the present invention.

The receiver examines whether the header-compressed ROHC packet is received or not in step 501.

Upon receiving the ROHC packet, the receiver appends the ROHC channel ID and the ROHC padding corresponding to the corresponding SF to the ROHC packet in step 503. For example, the packet with the ROHC channel ID and the padding appended is shown in FIG. 6B. The padding 601 is a predefined sequence indicative of the ROHC packet and is the same as the padding of FIG. 6A. The ROHC channel ID 603 is an identifier for discriminating the ROHC channel.

Next, the receiver identifies the SF of the ROHC packet; that is, the ROHC channel based on the ROHC channel ID in step 505.

In step 507, the receiver decompresses the header of the ROHC packet in the corresponding ROHC channel. After removing the ROHC channel ID and the ROHC padding, the receiver recovers the ROHC packet to the original packet before the compression.

In step 509, the receiver processes the recovered packet according to the corresponding SF. If the receiver is a terminal, the packet is processed according to the process of the terminal. If the receiver is a system equipment such as ACR, the packet is transmitted over a core network such as IP network.

When the header is compressed in the broadband wireless communication system, the MAC CS uses the ROHC channel ID to identify the SF of the ROHC packet header-compressed in the ROHC layer. Alternatively, instead of the ROHC channel ID, the SF ID can be utilized. Since the SF and the ROHC channel are in the one-to-one correspondence, the same effect can be achieved using the SF ID. In addition, using the SF ID, the CID according to the SF can be acquired right away based on the ROHC channel ID.

As set forth above, to compress the header in the broadband wireless communication system, the ID of the compression channel is used. Therefore, it is possible to identify the SF even in the header compression.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A transmitter in a wireless communication system, the transmitter comprising:
a compressor for compressing a header of a packet;
a processor for adding a compression channel IDentifier (ID) to the packet; and
a controller for identifying a Service Flow (SF) corresponding to the compression channel ID and processing the packet according to the SF.

2. The transmitter of claim 1, wherein the compressor compresses the header according to a RObust Header Compression (ROHC) scheme.

3. The transmitter of claim 1, wherein the processor appends the compression channel ID and a padding indicative of the compressed packet.

4. The transmitter of claim 1, wherein the compression channel ID is the same as an ID of the SF.

5. The transmitter of claim 1, wherein the controller confirms a Connection ID (CID) corresponding to the SF, and processes to send the packet with the compression channel ID removed to a receiver identified based on the CID.

6. A receiver in a wireless communication system, the receiver comprising:
a processor for adding a compression channel IDentifier (ID) corresponding to a Service Flow (SF) of a header-compressed packet; and
a decompressor for identifying a compression channel of the packet based on the compression channel ID and recovering the header of the packet in the corresponding compression channel.

7. The receiver of claim 6, wherein the decompressor recovers the header using a RObust Header Compression (ROHC) scheme.

8. The receiver of claim 6, wherein the processor appends the compression channel ID and a padding indicative of the compressed packet.

9. The receiver of claim 6, wherein the compression channel ID is the same as an ID of the SF.

10. A method for compressing a header of a packet in a wireless communication system, the method comprising:
compressing a header of a packet;
adding a compression channel IDentifier (ID) to the packet;
identifying a Service Flow (SF) corresponding to the compression channel ID; and
processing the packet according to the SF.

11. The method of claim 10, wherein the header is compressed using a RObust Header Compression (ROHC) scheme.

12. The method of claim 10, further comprising:
after appending the compression channel ID, appending a padding indicative of the compressed packet to the packet.

13. The method of claim 10, wherein the compression channel ID is the same as an ID of the SF.

14. The method of claim 10, wherein the packet processing comprises:
confirming a Connection ID (CID) corresponding to the SF; and
sending the packet with the compression channel ID removed to a receiver identified based on the CID.

15. A method for recovering a compressed header of a packet in a wireless communication system, the method comprising:
examining whether a header-compressed packet is received or not;
adding a compression channel IDentifier (ID) corresponding to a Service Flow (SF) of the packet;
identifying a compression channel of the packet based on the compression channel ID; and
recovering the header of the packet in the identified compression channel.

16. The method of claim 15, wherein the header is compressed using a RObust Header Compression (ROHC) scheme.

17. The method of claim 15, further comprising:
after appending the compression channel ID, appending a padding indicative of the compressed packet to the packet.

18. The method of claim 15, wherein the compression channel ID is the same as an ID of the SF.
